(19) United States
(12) Patent Application Publication
(10) Pub. No.: US 2009/0309918 A1
(43) Pub. Date: Dec. 17, 2009

(54) FLUID EJECTING APPARATUS

(75) Inventors: Takuo Yoshida, Sagamihara-shi (JP); Nobuhito Takahashi, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/484,847

(22) Filed: Jun. 15, 2009

(30) Foreign Application Priority Data
Jun. 16, 2008 (JP) 2008-156298

(51) Int. Cl. B41J 2/165

(52) U.S. Cl. 347/30

(57) ABSTRACT

A fluid ejecting apparatus includes: a plurality of ejection heads having ejection nozzles through which fluid is ejected; cap members that are provided so as to correspond to the ejection heads and form sealed spaces around the ejection nozzles in the ejection heads when brought into contact with the ejection heads; cap-member moving mechanisms that press the cap members against the corresponding ejection heads; a fluid suction unit that, while the cap members are pressed against the corresponding ejection heads, produces negative pressure in the sealed space of a selected ejection head to suck the fluid in the ejection head; cap-member selective-separation mechanisms that selectively separate the cap member from the corresponding ejection head having undergone suction; and a selective wiping mechanism that selectively wipes off the fluid deposited around the ejection nozzles in the ejection head separated from the corresponding cap member.

### BACKGROUND

1. Technical Field

The present invention relates to a technique for ejecting fluid from an ejection head.

2. Related Art

Ink jet printers can print high-quality images by ejecting a precise amount of ink from fine nozzles onto a precise position. By ejecting various fluids, instead of ink, onto substrates using this technique, it is possible to produce electrodes, sensors, biochip, etc.

In this technique, a dedicated ejection head is used to enable a precise amount of fluid, such as ink, to be ejected at a precise position. As time passes, the fluid supplied to the ejection head thickens because of the evaporation of moisture or the vaporization of constituent. It is impossible to eject a precise amount of fluid in the ejection head onto a precise position if the fluid is thickened. Therefore, nozzles are covered with a cap to prevent the fluid from becoming thick while they do not eject fluid. Even if the nozzles are covered with the cap, the fluid thickens with time. In such a case, the thickened fluid in the ejection head is sucked and new fluid is supplied (cleaning operation). Although the sucked fluid is of course wasted, it is possible to prevent thickening of the fluid in the ejection head and to allow adequate ejection of the fluid. After the cleaning operation, the fluid sucked from the ejection head is deposited around the nozzles. This causes another problem, such as clogging of the nozzles, if left untreated. Thus, after the cleaning operation, the fluid deposited around the nozzles (wiping operation) is wiped off.

Fluid ejecting apparatuses, such as ink jet printers, using these techniques typically have a plurality of ejection heads so that they can eject several types of fluid (for example, ink of different colors). Some apparatuses have a plurality of ejection heads so that they can eject a greater amount of fluid in a shorter time. In an apparatus having a plurality of ejection heads, not necessarily all the ejection heads contain thickened fluid. Japanese Unexamined Patent Application Publication No. 6-328727 proposes a technique to reduce the consumption of fluid by performing a cleaning operation only on the ejection head containing thickened fluid.

However, the proposed technique has a problem in that the consumption of fluid cannot be sufficiently reduced for the following reasons. That is, even if the cleaning operation is performed only on the ejection head containing thickened fluid, the caps of the other ejection heads have to be removed when the wiping operation is performed on the aforementioned ejection head. This evaporates the moisture in the fluid in the nozzles in the ejection heads not to be cleaned and accelerates thickening of the fluid in these ejection heads. Thus, performing the cleaning operation on the ejection head containing thickened fluid accelerates thickening of the fluid in the other ejection heads and shortens the cycle of the cleaning operation. For these reasons, it is difficult to sufficiently reduce the consumption of fluid with the proposed technique.

### SUMMARY

An advantage of some aspects of the invention is that it provides a technique for a fluid ejecting apparatus having a plurality of ejection heads to effectively reduce the consumption of fluid due to cleaning operation.

According to an aspect of the invention, a fluid ejecting apparatus includes: a plurality of ejection heads having ejection nozzles through which fluid is ejected; cap members that are provided so as to correspond to the ejection heads and form sealed spaces around the ejection nozzles in the ejection heads when brought into contact with the ejection heads; cap-member moving mechanisms that press the cap members against the corresponding ejection heads; a fluid suction unit that, while the cap members are pressed against the corresponding ejection heads, produces negative pressure in the sealed space of a selected ejection head to suck the fluid in the ejection head; cap-member selective-separation mechanisms that selectively separate the cap member from the corresponding ejection head having undergone suction; and a selective wiping mechanism that selectively wipes off the fluid deposited around the ejection nozzles in the ejection head separated from the corresponding cap member.

The fluid ejecting apparatus of the invention can eject fluid from the ejection heads having the ejection nozzles. The cap members are provided so as to correspond to the ejection heads. When the ejection heads do not eject fluid, the cap members are pressed against the ejection heads to form the sealed spaces around the ejection nozzles. Thus, thickening or degradation of the fluid due to evaporation of moisture can be prevented. Even if the nozzles are covered with the cap members, fluid in some ejection heads may thicken or degrade. In such a case, while the cap members are pressed against the ejection heads, negative pressure is applied to the sealed space formed between a selected ejection head and the corresponding cap member. Thus, the fluid in the ejection head is sucked. Then, the cap member corresponding to the ejection head after suction is selectively separated from the ejection head, and fluid deposited around the ejection nozzles in the aforementioned ejection head can be wiped off.

Thus, when fluid in some ejection heads thickens or degrades, suction of the fluid and wiping of the fluid deposited around the ejection nozzles can be performed only on these ejection heads. Because the other ejection heads can be kept capped, thickening or degradation of fluid in these ejection heads is not accelerated. As a result, in the fluid ejecting apparatus, thickening or degradation of fluid in the ejection head can be suppressed. Accordingly, the number of suction operations to recover the property of fluid is reduced, and thus, the total amount of sucked fluid can be reduced.

In this case, the cap members may be pressed against or separated from the ejection heads independently, and the fluid deposited around the ejection nozzles may be simultaneously wiped off from the ejection heads that are separated from the corresponding cap members.

Since thickening or degradation of fluid in the ejection heads may occur in any of the ejection heads, it is preferable that the cap members can be pressed against or separated from the ejection heads individually. In contrast, to wipe off the fluid deposited around the ejection nozzles, the cap members have to be separated from the ejection heads. That is, only fluid deposited on the ejection heads that are separated from the cap members needs to be wiped off, and the ejection heads do not need to be wiped individually. Accordingly, by simultaneously wiping the ejection heads separated from the corresponding cap members, the structure of the fluid ejecting apparatus can be simplified.

### BRIEF DESCRIPTION OF THE DRAWINGS

The invention will be described with reference to the accompanying drawings, wherein like numbers reference like elements.

FIG. 1 is a schematic diagram showing the structure of a fluid ejecting apparatus according to this embodiment, using an ink jet printer as an example.

FIG. 2 is a bottom view of a carriage case having a plurality of ejection heads.

FIG. 3 shows the structure of a maintenance mechanism installed in the ink jet printer according to this embodiment.

FIG. 4 is a flowchart of maintenance processing performed in a maintenance operation.

FIGS. 5A and 5B show suction of ink by applying negative pressure produced by a suction pump to a specified ejection head.

FIGS. 6A to 6D show that the ejection head after cleaning operation is wiped and capped.

FIGS. 7A and 7B show a modification in which wiping operation is performed simultaneously on ejection heads whose cap units are lowered.

### DESCRIPTION OF EXEMPLARY EMBODIMENTS

To clarify the invention, embodiments will be described below in the following order.
A. Structure of Apparatus

A-1. Structure of Fluid Ejecting Apparatus

A-2. Structure of Maintenance Mechanism
B. Maintenance Operation According to This Embodiment
C. Modification

### A. Structure of Apparatus

### A-1. Structure of Fluid Ejecting Apparatus

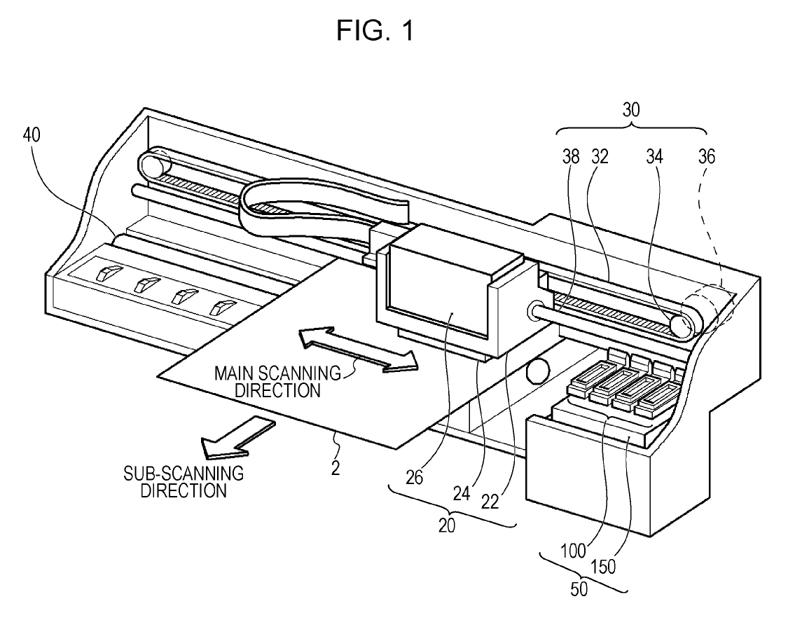

FIG. 1 is a schematic diagram showing the structure of a fluid ejecting apparatus according to this embodiment, using an ink jet printer as an example. As shown in FIG. 1, an ink jet printer 10 includes a carriage 20 that forms ink dots on a printing medium 2 while reciprocating in a main scanning direction, a driving mechanism 30 that reciprocates the carriage 20, a platen roller 40 that feeds the printing medium 2, and a maintenance mechanism 50 that performs maintenance to enable proper printing. The carriage 20 includes ink cartridges 26 containing ink, a carriage case 22 to which the ink cartridges 26 are mounted, and ejection heads 24 for ejecting ink mounted on the bottom surface (the surface facing the printing medium 2) of the carriage case 22. Ink in the ink cartridges 26 is guided to the ejection heads 24, and the ejection heads 24 eject a precise amount of ink onto the printing medium 2. Thus, an image is printed.

The driving mechanism 30 that reciprocates the carriage 20 includes a guide rail 38 extending in the main scanning direction, a timing belt 32 having teeth formed inside thereof, a driving pulley 34 that engages with the teeth of the timing belt 32, a stepping motor 36 for driving the driving pulley 34. Part of the timing belt 32 is fixed to the carriage case 22. By driving the timing belt 32, the carriage case 22 can be moved along the guide rail 38. Because the timing belt 32 and the driving pulley 34 are engaged with each other by the teeth, driving of the driving pulley 34 by the stepping motor 36 can precisely move the carriage case 22 according to the drive amount.

The platen roller 40 that feeds the printing medium 2 is driven by a driving motor and a gear mechanism (not shown) so that it can feed the printing medium 2 in the sub-scanning direction by a predetermined amount.

The maintenance mechanism 50 is provided in an area called “home position” located outside a printing area. The maintenance mechanism 50 basically consists of cap units 100 and a pump unit 150. The cap units 100 are provided so as to correspond to the ejection heads 24. The cap units 100 can be raised and lowered individually. The structure of the maintenance mechanism 50 will be described below in detail.

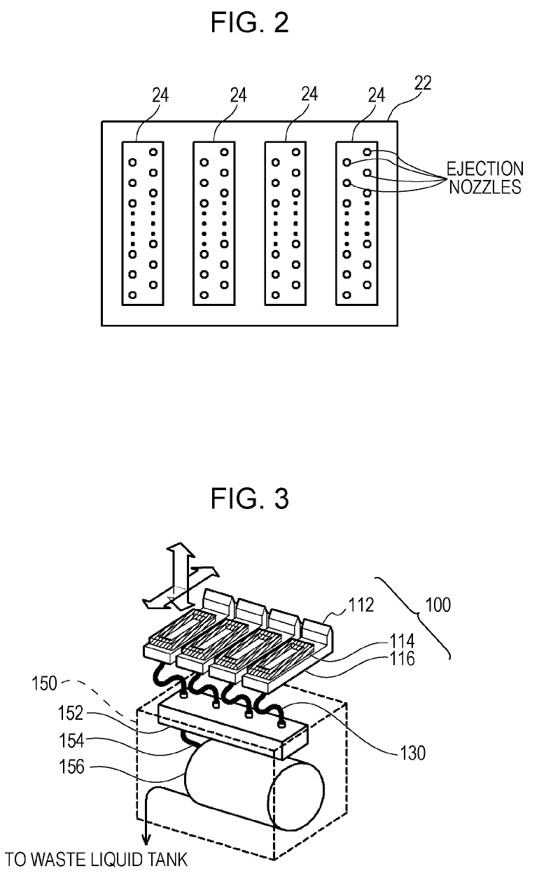

FIG. 2 is a bottom view of the carriage case 22 (viewed from the printing medium 2 side). As shown in FIG. 2, a plurality of ejection heads 24 are provided on the bottom surface of the carriage case 22. The carriage case 22 according to this embodiment has four ejection heads 24. This is because the ink jet printer 10 according to this embodiment can eject four types of ink, namely, cyan ink, magenta ink, yellow ink, and black ink, and the ejection heads 24 are provided so as to correspond to these four types of ink. Each ejection head 24 has a plurality of ejection nozzles arranged in a staggered manner at a predetermined interval. These ejection heads 24 can print an image on the printing medium 2 by ejecting ink from the ejection nozzles.

### A-2. Structure of Maintenance Mechanism

FIG. 3 shows the structure of the maintenance mechanism 50 installed in the ink jet printer 10 according to this embodiment. As described above, the maintenance mechanism 50 basically consists of the cap units 100 and the pump unit 150. The cap units 100 are provided so as to correspond to the ejection heads 24. As shown in FIG. 2, in this embodiment, the number of ejection heads 24 is four. Thus, the number of cap units 100 is also four.

As shown in FIG. 3, each cap unit 100 includes a substantially rectangular cap plate 116, a rectangular frame-shaped cap 114 that is formed of an elastic resin material, such as rubber, and is disposed on substantially the center of the top surface of the cap plate 116, and a plate-like wiper blade 112 projected from an end of the top surface of the cap plate 116. The four cap units 100 can be raised and lowered individually by actuators (not shown). By moving the carriage 20 to the home position and raising the cap units 100, the caps 114 are pressed against the ejection heads 24. Thus, thickening of ink in the ejection nozzles can be prevented.

Small discharge ports are provided inside the rectangular frame-shaped caps 114. The discharge ports are connected to the pump unit 150 through tubes 130 made of resin.

The pump unit 150 accommodates a switching unit 152 to which the tubes 130 extending from the cap units 100 are connected and a suction pump 156 that produces negative pressure to suck the liquid. The tubes 130 extending from the cap units 100 are integrated into one path in the switching unit 152 and is connected to the suction pump 156 via a connecting tube 154 made of resin. Paths in the switching unit 152 to which the tubes 130 are connected are provided with open/close valves. These open/close valves are normally closed. By selecting an open/close valve and opening it, negative pressure from the suction pump 156 is guided to the corresponding cap unit 100. Thus, the cleaning operation to suck the ink in the ejection head 24 can be performed.

Furthermore, the cap units 100 according to this embodiment, in a lowered state, can be moved forward and backward. That is, actuators (not shown) for moving the cap units 100 forward and backward are provided separately from the actuators for moving the cap units 100 in the vertical direction. When one of the cap units 100 is lowered to a predetermined position, the cap unit 100 can be moved in the forward and backward. As described above, the cap units 100 have the wiper blades 112 projecting from one end thereof. Therefore, by moving the cap units 100 in a lowered state forward and backward, ink deposited around the ejection nozzles can be wiped off with the wiper blades 112 (wiping operation).

Typically, sucked ink is deposited around the ejection nozzles right after the cleaning operation. If left untreated, the deposited ink becomes solid, possibly causing failure such as clogging of the ejection nozzles. Therefore, after the cleaning operation, the wiping operation has to be performed to wipe off the ink deposited around the ejection nozzles. In the ink jet printer 10 according to this embodiment, to reduce the consumption of ink associated with the maintenance operation (the cleaning operation and the subsequent wiping operation), the maintenance operation is performed as follows.

### B. Maintenance Operation According to This Embodiment

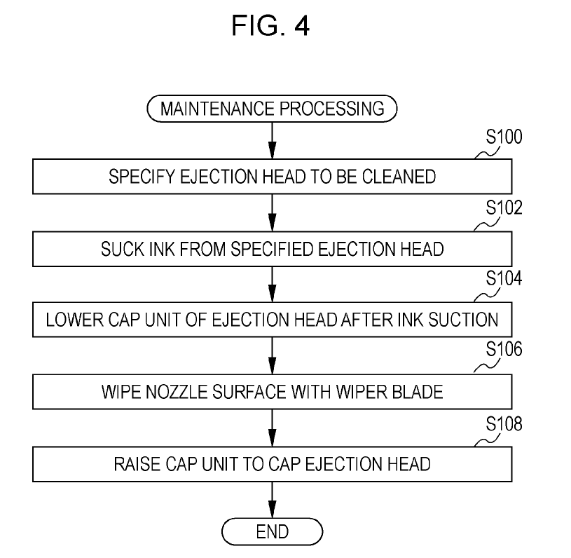

FIG. 4 is a flowchart of maintenance processing performed during the maintenance operation by the ink jet printer 10 according to this embodiment. This maintenance processing is started when the carriage 20 is located at the home position and the cap units 100 are pressed against the ejection heads 24.

When the maintenance processing starts, first, the ejection head 24 to be subjected to the cleaning operation is specified (step S100). That is, as described above with reference to FIG. 3, the ink jet printer 10 according to this embodiment has the switching unit 152 having the open/close valves, and it is possible to apply negative pressure only to the ejection head 24 corresponding to the opened valve to suck the ink. Thus, the ejection head 24 to be subjected to the cleaning operation to suck the ink is specified among four ejection heads 24. The ejection head 24 to be subjected to the cleaning operation is preliminarily identified by an operator by, for example, printing a predetermined test pattern and is specified via an operation panel (not shown) provided on the ink jet printer 10.

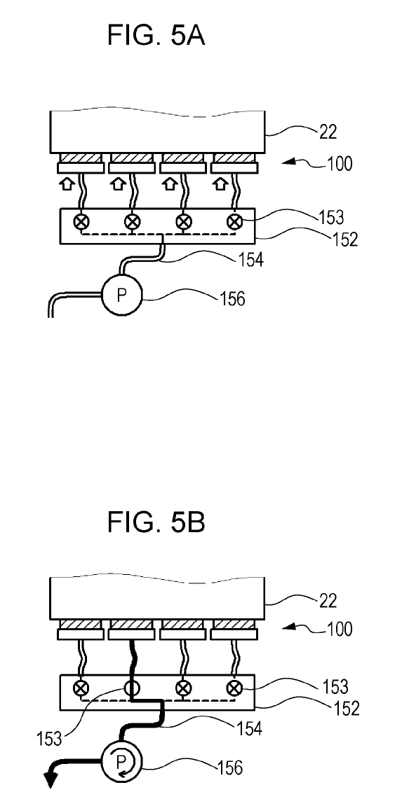

When the ejection head 24 to be subjected to the cleaning operation is specified, negative pressure produced by the suction pump 156 is applied to the specified ejection head 24 to suck the ink in the ejection head 24 (step S102). FIGS. 5A and 5B show suction of ink by applying negative pressure produced by the suction pump 156 to the specified ejection head 24. FIG. 5A shows that the cap units 100 are raised and pressed against the ejection heads 24 to seal the ejection nozzles in the ejection heads 24. The operation in which the cap units 100 are pressed against the ejection heads 24 to seal the ejection nozzles is sometimes referred to as “capping operation”.

The cap units 100 are connected to the switching unit 152 via the tubes 130 extending from the bottom portions thereof. Dashed lines in the switching unit 152 represent paths formed in the switching unit 152. The paths have the open/close valves 153. Before ink suction, the open/close valves 153 in the paths are closed, and the suction pump 156 is stopped.

When the ejection head 24 to be subjected to the cleaning operation is specified in this state (step S100 in FIG. 4), first, the corresponding open/close valve 153 in the switching unit 152 is opened, and the suction pump 156 is activated. Then, ink is selectively sucked from the specified ejection head 24, and thus, the cleaning operation can be performed. FIG. 5B shows that the cleaning operation is selectively performed on the second ejection head 24 from the left. After the open/close valve 153 corresponding to the specified ejection head 24 is opened while those corresponding to the non-specified ejection heads 24 are kept closed, the suction pump 156 is activated. This causes negative pressure produced by the suction pump 156 to act only on the specified ejection head 24 to suck the ink. FIG. 5B shows that the ink sucked from the specified ejection head 24 is discharged from the suction pump 156 through the path in the switching unit 152. Thus, in step S102 in FIG. 4, a predetermined amount of ink is sucked from the specified ejection head 24.

When the cleaning operation on the specified ejection head 24 is completed, the suction pump 156 is stopped, and the open/close valve 153 in the switching unit 152 is closed again. Then, only the corresponding cap unit 100 is lowered and separated from the ejection head 24 (step S104). At this time, the ejection heads 24 not having undergone the cleaning operation are covered with the cap units 100. As described above with reference to FIG. 3, the cap units 100 are provided so as to correspond to the ejection heads 24 and can be pressed against or separated from the ejection heads 24 individually.

When the cap unit 100 is lowered by a predetermined amount, the cap unit 100 is moved forward and backward (step S106). This causes the wiper blade 112 of the cap unit 100 to move while being pressed against a nozzle surface (the surface having the ejection nozzles) of the ejection head 24. Thus, ink deposited on the nozzle surface can be wiped off (wiping operation).

After the wiping operation, the cap unit 100 in a lowered state is returned to where it was just before starting the wiping operation. Then, the cap unit 100 is raised and pressed against the ejection head 24 again (step S108).

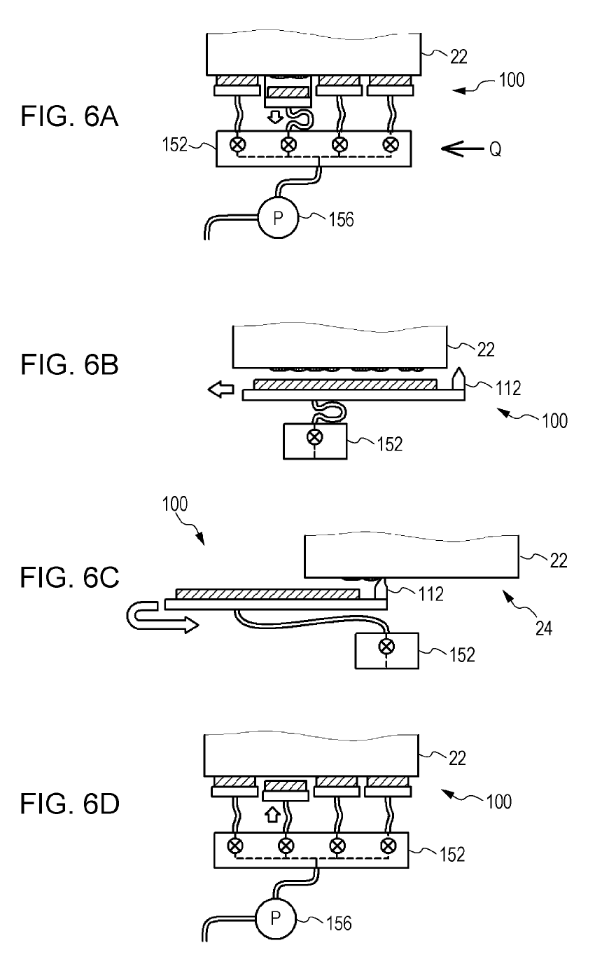

FIGS. 6A to 6D show that the ejection head 24 after the cleaning operation is wiped and capped. FIG. 6A shows that only the cap unit 100 corresponding to the ejection head 24 having undergone the cleaning operation is lowered (step S104 in FIG. 4). In the example shown in FIG. 6A, only the cap unit 100 corresponding to the second ejection head 24 from the left is lowered, and the cap units 100 corresponding to the other ejection heads 24 are pressed against the ejection heads 24.

FIG. 6B shows the cap unit 100 in a lowered state, viewed in the direction shown by an arrow Q in FIG. 6A. As shown in FIG. 6B, when the cap unit 100 is lowered, the tip of the wiper blade 112 is positioned at the same level as the nozzle surface of the ejection head 24. The cap unit 100 is then moved in a direction shown by a white arrow in FIG. 6B. This causes the tip of the wiper blade 112 to move while being in contact with the nozzle surface of the ejection head 24, wiping off the ink deposited on the nozzle surface. FIG. 6C shows that the cap unit 100 is reciprocated while the wiper blade 112 wipes off the ink (step S106 in FIG. 4). This wiping operation is performed only on the ejection head 24 having undergone the cleaning operation and whose cap unit 100 is lowered. The ejection heads 24 not having undergone the cleaning operation are covered with the corresponding cap units 100.

When the wiping operation is finished, the cap unit 100 is returned to where it was just before starting the wiping operation. Then, the cap unit 100 is raised again and is pressed against the ejection head 24 (step S108 in FIG. 4). With the capping operation, the maintenance processing shown in FIG. 4 is finished.

As has been described, the ink jet printer 10 according to this embodiment has the cap units 100 corresponding to the ejection heads 24. The cleaning operation can be performed only on the ejection head 24 containing thickened ink by switching the cap unit 100 to which the switching unit 152 applies negative pressure. Furthermore, in this embodiment, the wiping operation can be individually performed by individually raising and lowering the cap units 100. Thus, the wiping operation can be performed only on the ejection head 24 having undergone the cleaning operation. As a result, the ejection heads 24 not having undergone the cleaning operation can be kept capped. Because the cleaning operation can be performed only on the ejection head 24 containing thickened ink without thickening ink in the other ejection heads 24, the consumption of ink due to cleaning operation can be reduced.

In addition, because the ejection heads 24 not having undergone the cleaning operation can be kept capped during the wiping operation of the ejection head 24 having undergone the cleaning operation, ink droplets scattered by the wiping operation can be prevented from being deposited on the other ejection heads 24.

### C. Modification

As has been described, in the ink jet printer 10 according to this embodiment, the cap units 100 can be individually raised and lowered, and the cleaning operation and the wiping operation can be performed on the ejection heads 24 individually. Since thickening of ink in the ejection heads 24 may occur in any of the ejection heads 24, it is necessary that the cleaning operation can be performed on the ejection heads 24 individually. In contrast, the wiping operation should be performed only on the ejection head 24 having undergone the cleaning operation and does not need to be performed on all the ejection heads 24 individually. Accordingly, by performing the wiping operation simultaneously on the ejection heads 24 separated from the corresponding cap units 100, the structure of the maintenance mechanism 50 can be simplified.

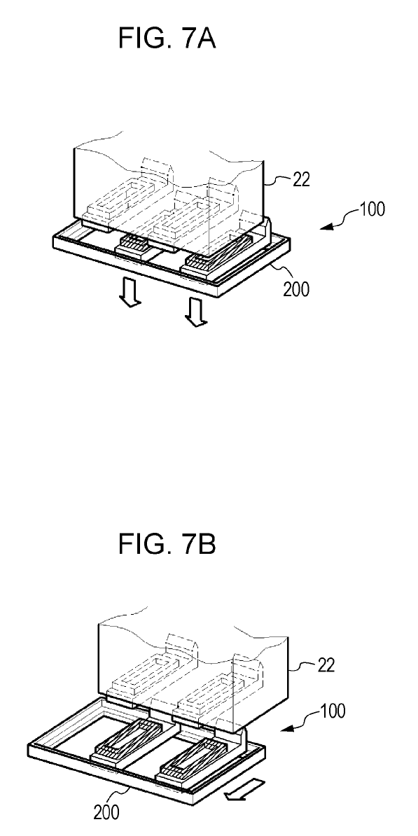

FIGS. 7A and 7B show an ink jet printer 10 according to the modification, in which the wiping operation is performed simultaneously on the ejection heads 24 whose cap units 100 are lowered. FIG. 7A shows that only the cap units 100 corresponding to two ejection heads 24 having undergone the cleaning operation are lowered. In this modification, the lowered cap units 100 are attached to a driving frame 200 for wiping operation. The wiping operation is performed not by driving the cap units 100 individually, but by driving the driving frame 200.

FIG. 7B shows that the wiping operation is performed by driving the driving frame 200. In the example shown in FIG. 7B, two cap units 100 are lowered and attached to the driving frame 200. By driving the driving frame 200, the wiping operation can be performed simultaneously on the two ejection heads 24 corresponding to these cap units 100. In this structure, although a mechanism for raising and lowering the cap unit 100 has to be provided for each ejection head 24, the number of mechanisms for moving the cap units 100 forward and backward may be one. Accordingly, the structure of the maintenance mechanism 50 can be simplified.

Although the printing apparatus according to this embodiment has been described above, the invention is not limited to the above-described embodiments. The invention can be variously embodied within the scope not departing from the gist thereof.

For example, in the above-described embodiment, the wiper blades 112 are provided as part of the cap units 100. However, the wiper blades 112 may be provided separately from the cap units 100, and the wiping operation may be performed by driving only the wiper blades 112 after the cap units 100 are lowered.

The entire disclosure of Japanese Patent Application No. 2008-156298, filed Jun. 16, 2008 is expressly incorporated by reference herein.

What is claimed is:

1. A fluid ejecting apparatus comprising:
a plurality of ejection heads having ejection nozzles through which fluid is ejected;
cap members that are provided so as to correspond to the ejection heads and form sealed spaces around the ejection nozzles in the ejection heads when brought into contact with the ejection heads;
cap-member moving mechanisms that press the cap members against the corresponding ejection heads;
a fluid suction unit that, while the cap members are pressed against the corresponding ejection heads, produces negative pressure in the sealed space of a selected ejection head to suck the fluid in the ejection head;
cap-member selective-separation mechanisms that selectively separate the cap member from the corresponding ejection head having undergone suction; and
a selective wiping mechanism that selectively wipes off the fluid deposited around the ejection nozzles in the ejection head separated from the corresponding cap member.

2. The fluid ejecting apparatus according to claim 1,
wherein the cap-member moving mechanisms are capable of pressing the plurality of cap members against the corresponding ejection heads individually,
wherein the cap-member selective-separation mechanisms are capable of separating the cap members from the corresponding ejection heads individually, and
wherein the selective wiping mechanism simultaneously wipes off the fluid deposited around the ejection nozzles in the ejection heads separated from the cap members.
